(19) United States
(12) Patent Application Publication
(10) Pub. No.: US 2014/0166592 A1
(43) Pub. Date: Jun. 19, 2014

(54) MULTI-DECK SHAKER

(71) Applicant: Benjamin Lanning Holton, Cincinnati, OH (US)

(72) Inventor: Benjamin Lanning Holton, Cincinnati, OH (US)

(73) Assignee: M-I L.L.C., Houston, TX (US)

(21) Appl. No.: 14/118,392

(22) PCT Filed: May 16, 2012
(86) PCT No.: PCT/US2012/038096

§ 371 Date: Feb. 12, 2014

Related U.S. Application Data
(60) Provisional application No. 61/486,683, filed on May 16, 2011.

(51) Int. Cl. B01D 33/41

(52) U.S. Cl. CPC B01D 33/41
USPC 210/780; 210/330

(57) ABSTRACT

The present disclosure relates to methods and apparatuses to separate solids from a drilling fluid. A shaker in accordance with the present disclosure includes a first screening deck having a first channel and a second channel, and also includes a second screening deck. Drilling fluid received by the first channel and separated through the first screening deck is directed to the second screening deck, and drilling fluid received by the second channel and separated through the first screening deck is directed to a sump of the shaker.

### BACKGROUND

1. Field of the Invention

Embodiments disclosed herein generally relate to a shaker for separating solids from fluid. In particular, embodiments disclosed herein relate to a shaker having at least two decks, in which the shaker may be used to allow processing of drilling fluid both in series and in parallel.

2. Background Art

Oilfield drilling fluid, often called “mud,” serves multiple purposes in the industry. Among its many functions, the drilling mud acts as a lubricant to cool rotary drill bits and facilitate faster cutting rates. Typically, the mud is mixed at the surface and pumped downhole at high pressure to the drill bit through a bore of the drillstring. Once the mud reaches the drill bit, it exits through various nozzles and ports where it lubricates and cools the drill bit. After exiting through the nozzles, the “spent” fluid returns to the surface through an annulus formed between the drillstring and the drilled wellbore.

Furthermore, drilling mud provides a column of hydrostatic pressure, or head, to prevent “blow out” of the well being drilled. This hydrostatic pressure offsets formation pressures thereby preventing fluids from blowing out if pressurized deposits in the formation are breeched. Two factors contributing to the hydrostatic pressure of the drilling mud column are the height (or depth) of the column (i.e., the vertical distance from the surface to the bottom of the wellbore) itself and the density (or its inverse, specific gravity) of the fluid used. Depending on the type and construction of the formation to be drilled, various weighting and lubrication agents are mixed into the drilling mud to obtain the right mixture. Typically, drilling mud weight is reported in “pounds,” short for pounds per gallon. Generally, increasing the amount of weighting agent solute dissolved in the mud base will create a heavier drilling mud. Drilling mud that is too light may not protect the formation from blow outs, and drilling mud that is too heavy may over invade the formation. Therefore, much time and consideration is spent to ensure the mud mixture is optimal. Because the mud evaluation and mixture process is time consuming and expensive, drillers and service companies prefer to reclaim the returned drilling mud and recycle it for continued use.

Another significant purpose of the drilling mud is to carry the cuttings away from the drill bit at the bottom of the borehole to the surface. As a drill bit pulverizes or scrapes the rock formation at the bottom of the borehole, small pieces of solid material are left behind. The drilling fluid exiting the nozzles at the bit acts to stir-up and carry the solid particles of rock and formation to the surface within the annulus between the drillstring and the borehole. Therefore, the fluid exiting the borehole from the annulus is a slurry of formation cuttings in drilling mud. Before the mud can be recycled and re-pumped down through nozzles of the drill bit, the cutting particulates are removed.

Apparatuses in use today to remove cuttings and other solid particulates from drilling fluid are commonly referred to in the industry as shale shakers or vibratory separators. A shaker is a vibrating sieve-like table or screening deck upon which returning solids laden drilling fluid is deposited, and through which drilling fluid, that has been separated from much of the solids, emerges from the shaker. Typically, the shaker is an angled table with a generally perforated filter screen bottom, also known as a “deck.” Returning drilling fluid is deposited at a feed end of the shaker. As the drilling fluid travels along the length of the vibrating table, the fluid falls through the perforations to a reservoir below leaving solid particulate material behind. The vibrating action of the shaker table conveys solid particles left behind until they fall off the discharge end of the shaker table. The deck may be at an angle relative to ground. In some shakers, the angle of inclination of the deck results in the movement of particulates in a generally upward direction, while others are inclined such that the movement of particulates is in a generally downward direction, and still other shakers are not inclined or angled relative to the ground. Regardless, table inclination and/or design variations of existing shakers should not be considered a limitation of the present disclosure.

The amount of vibration and the angle of inclination of the shaker decks may be adjustable to accommodate various drilling fluid flow rates and particulate percentages in the drilling fluid. After the fluid passes through the perforated bottom of the deck of the shaker, it can either return to service in the borehole immediately, be stored for measurement and evaluation, or pass through other equipment (e.g., a drying shaker, centrifuge, or a smaller sized shale shaker) to further remove smaller cuttings.

A typical shaker with a screening deck includes of an elongated, box-like, rigid bed, and a screen attached to, and extending across, the bed. The bed is vibrated as the material to be separated is introduced to the screen. The vibrations, often in conjunction with gravity, move the relatively large size material along the screen and off the end of the bed. The bed is typically vibrated by pneumatic, hydraulic, or rotary vibrators, in a conventional manner. In certain shakers, multiple stages of screening may be used to refine the solids laden fluid to a desired purity. In order to reduce space requirements, multiple screening decks may be disposed in a single shaker.

Referring to FIG. 1, a perspective view of a multi-deck shaker 100 is shown. The multi-deck shaker 100 includes a top screen deck 102, a middle screen deck 104, and a bottom screen deck 106. Solid laden fluid is introduced to the shaker 100 on the top screen deck 102. Fluid and solids smaller than the top screen mesh pass through the top screen deck 102, while solids larger than the top screen mesh remain on the top screen deck 102 and are removed from the shaker 100.

In a shaker having a series configuration, effluent from the top screen deck 102 is directed to the middle screen deck 104 by a first flowback pan (not shown) disposed below the top screen deck 102. Solids larger than the mesh of the middle screen deck 104 do not pass through the middle screen deck 104 and are discarded from the shaker 100, while effluent from the middle screen deck 104 is directed to the bottom screen deck 106. Effluent from the bottom screen deck 106 may be collected in a sump (not shown), while solids too large to pass through the bottom screen deck 106 are removed from the shaker 100 and are discarded. Thus, in series operation, fluid is processed by the top screen deck 102, the middle screen deck 104, and the bottom screen deck 106 in order. A multi-deck shaker configured to process fluid in series may remove more solids from the fluid being processed and may be used in selective screening applications where specific solids are recovered for re-use.

Another shaker having a parallel fluid processing configuration may be used instead of the series configuration, described above. In a parallel configuration, effluent from the top screen deck 102 is divided into two streams by a first flowback pan (not shown). One of the streams is directed to the middle screen deck 104, while the other stream is directed to the bottom screen deck 106. Effluent passing through the middle screen deck 104 and the bottom screen deck 106 may then be collected in a sump (not shown) for re-use. A multi-deck shaker configured to process fluid in parallel may have a higher fluid capacity for a given mesh size of the screen decks 102, 104, and 106, and thus, may process more fluid in a given time than a shaker configured to process fluid in series.

Accordingly, there exists a need for a multi-deck shaker that may be operated in series or in parallel. Furthermore, there exists a need for a multi-deck shaker that may be selectively switched from series mode to parallel mode, or from parallel mode to series mode.

### SUMMARY OF THE DISCLOSURE

In one aspect, embodiments disclosed herein relate to a shaker to separate solids from a fluid. The shaker includes a first screening deck having a first channel and a second channel, and a second screening deck. Fluid received by the first channel and separated through the first screening deck is directed to the second screening deck, and fluid received by the second channel and separated through the first screening deck is directed to a sump of the shaker.

In another aspect, embodiments disclosed herein relate to a method to separate solids from drilling fluid. The method includes receiving drilling fluid onto a first channel of a first screening deck, the first screening deck having the first channel and a second channel, separating solids from drilling fluid in the first channel of the first screening deck, directing drilling fluid from the first channel of the first screening deck onto a second screening deck, and separating solids from drilling fluid in the second screening deck. Drilling fluid received by the second channel and separated through the first screening deck is directed to a sump of the shaker.

In yet another aspect, embodiments disclosed herein relate to a method to separate solids from drilling fluid. The method includes operating a shaker in a series configuration to process drilling fluid, including receiving drilling fluid in a first channel of a first screening deck of the shaker, the first screening deck having the first channel and a second channel, separating solids from drilling fluid in the first channel of the first screening deck, directing drilling fluid from the first channel of the first screening deck onto a second screening deck of the shaker, separating solids from drilling fluid in the second screening deck, and directing drilling fluid from the second screening deck to a sump of the shaker. The method further includes operating the shaker in a parallel configuration to process drilling fluid, including receiving drilling fluid in the second channel of the first screening deck of the shaker, separating solids from drilling fluid in the second channel of the first screening deck, directing drilling fluid from the second channel of the first screening deck to the sump of the shaker, receiving drilling fluid in the second screening deck of the shaker, separating solids from drilling fluid in the second screening deck, and directing drilling fluid from the second screening deck to the sump of the shaker. The method yet further includes adjusting between operating the shaker in the series configuration and in the parallel configuration to process drilling fluid.

Other aspects and advantages of the invention will be apparent from the following description and the appended claims.

### BRIEF DESCRIPTION OF DRAWINGS

FIG. 1 is a cross-sectional view of a multi-deck shaker of the prior art.

FIGS. 2A-2F are multiple views of a multi-deck shaker according to one or more embodiments of the present disclosure.

FIGS. 3-10 are multiple views of block diagrams of flow configurations within a shaker according to one or more embodiments of the present disclosure.

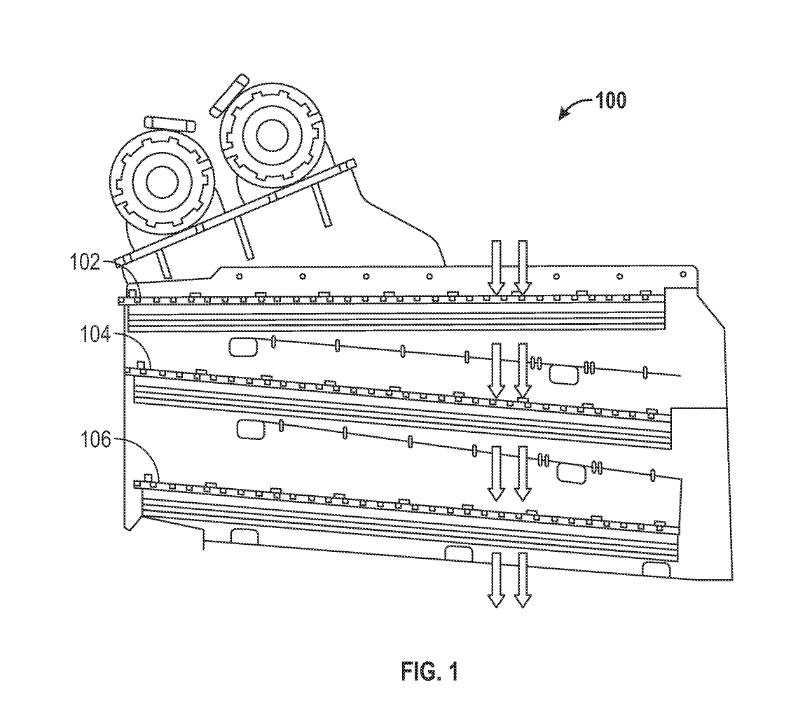

### DETAILED DESCRIPTION

In one aspect, embodiments disclosed herein relate to apparatuses and methods to separate solids from a drilling fluid. In particular, embodiments of the present disclosure provide for a shaker, such as a multi-deck shaker, having a first screening deck and a second screening deck, in which the screening decks may be operated in a series configuration and/or a parallel configuration when separating solids from the drilling fluid. As such, embodiments disclosed herein may relate to apparatuses and methods to increase the efficiency of a shaker, such as by providing drilling fluid to multiple decks of a shaker, as desired.

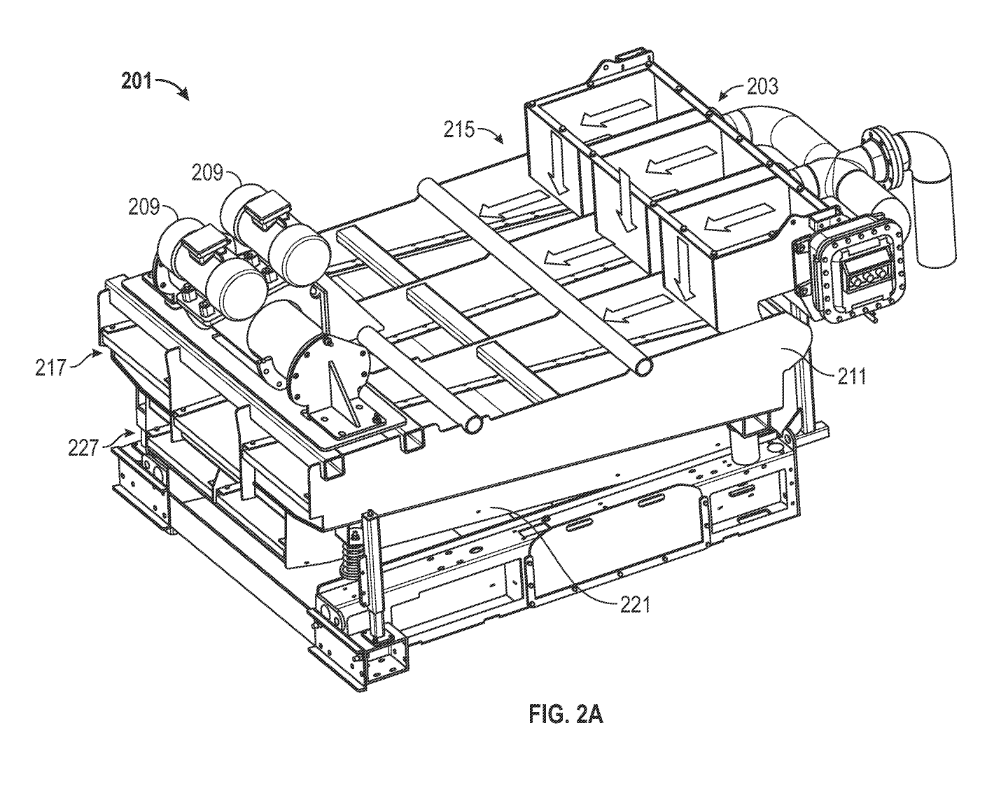

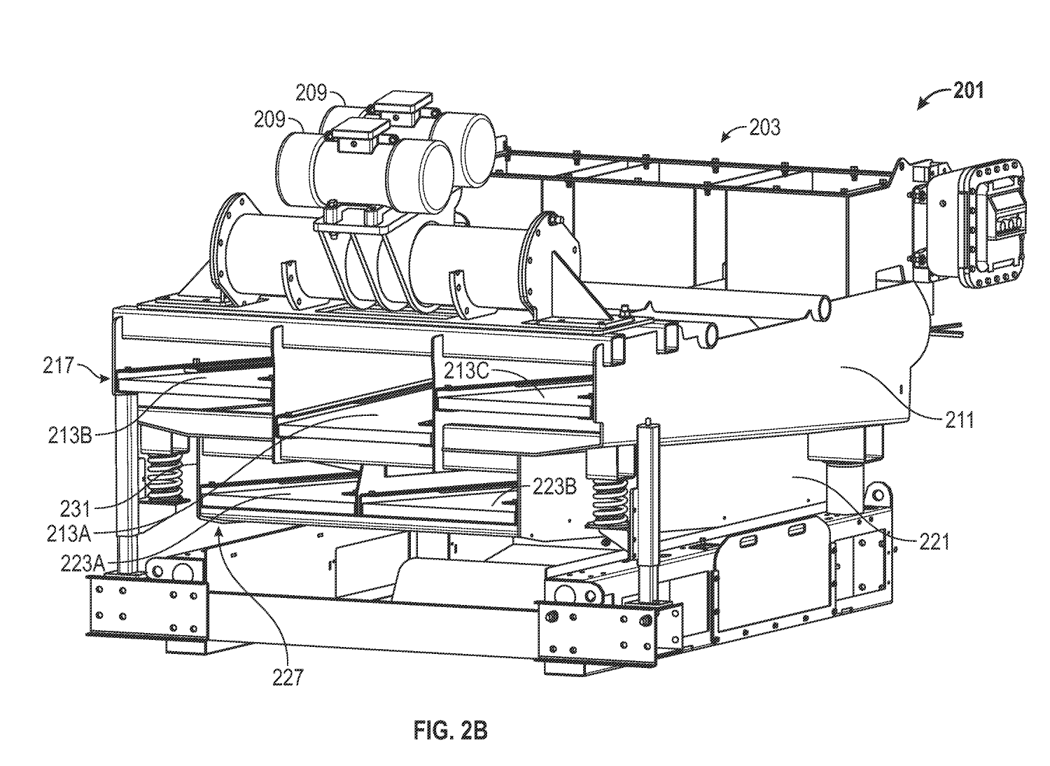

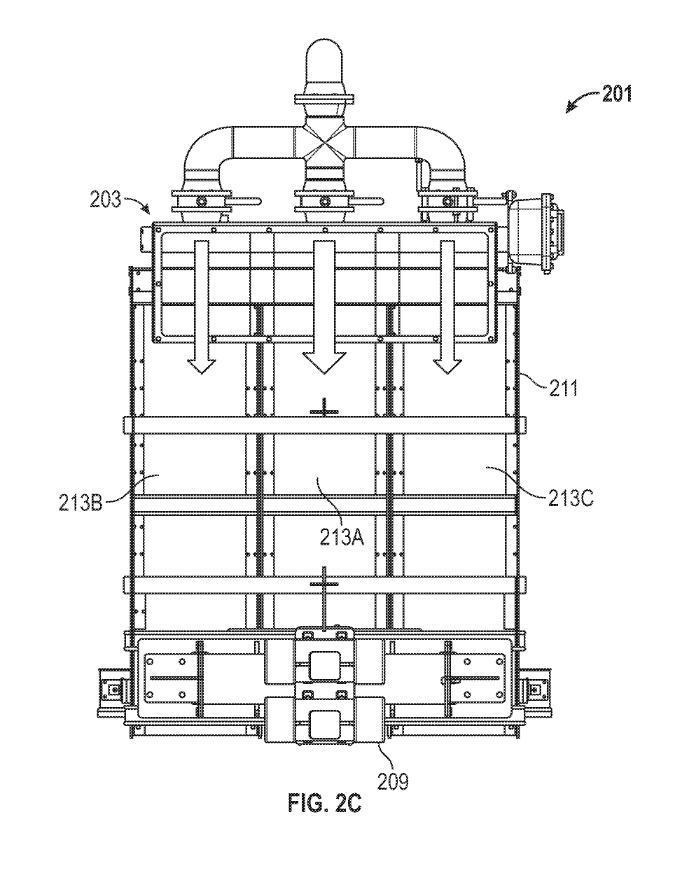

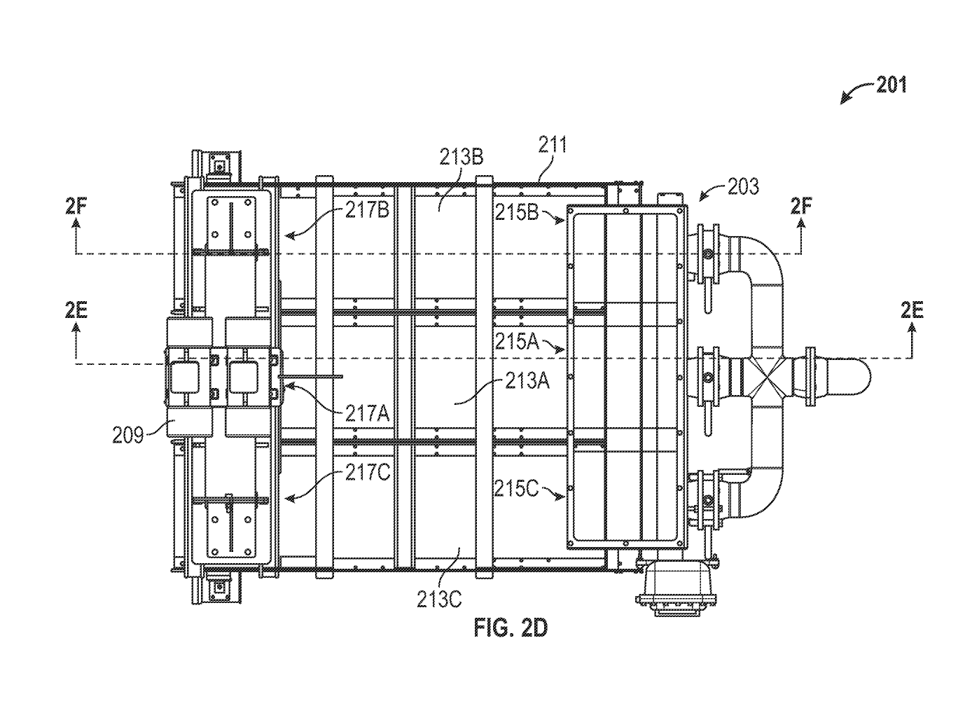

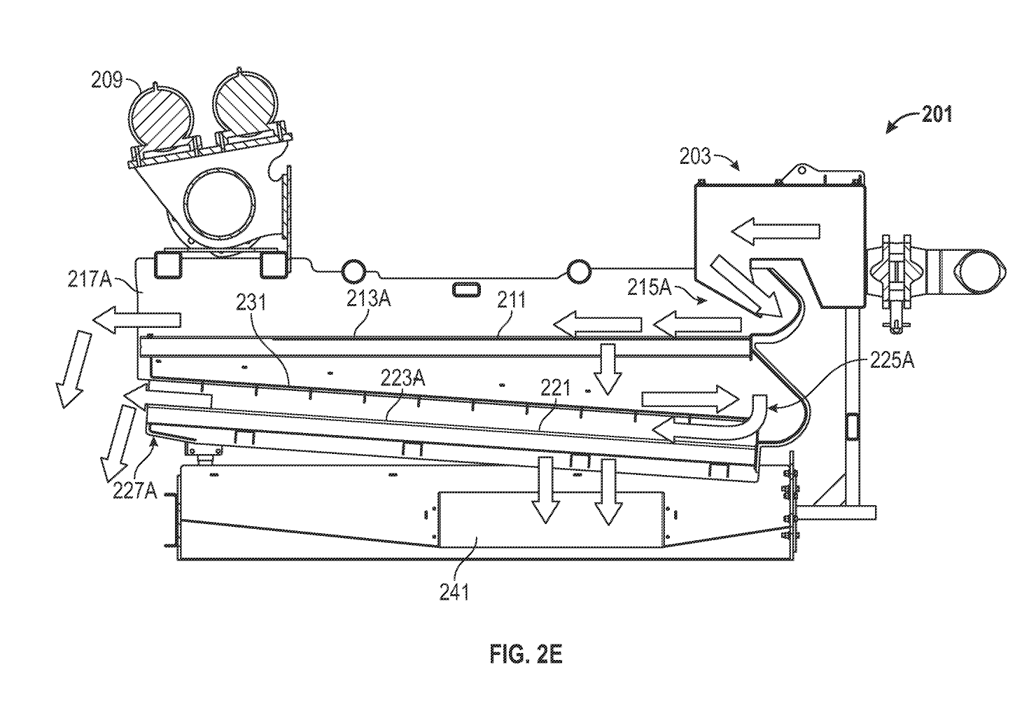

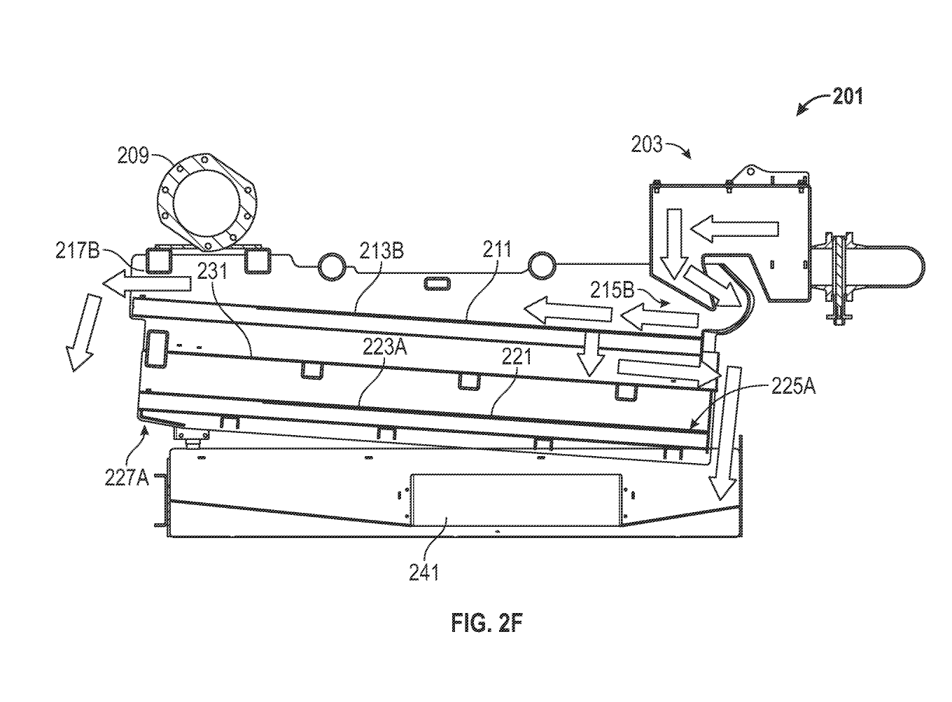

Referring now to FIGS. 2A-F, multiple views of a shaker 201 in accordance with one or more embodiments of the present disclosure are shown. Particularly, FIG. 2A shows a perspective view of the shaker 201, FIG. 2B shows another perspective view of the shaker 201, FIG. 2C shows a top view of the shaker 201, FIG. 2D shows another top view of the shaker 201, FIG. 2E shows a cross-sectional view of the shaker 201, and FIG. 2F shows another cross-sectional view of the shaker 201. The shaker 201 may include multiple screening decks. As shown in FIGS. 2A-F, the shaker 201 may include a first screening deck 211, such as a top screening deck, and a second screening deck 221, such as a bottom screening deck positioned beneath the top screening deck. Further, other screening decks, such as a third and/or a fourth screening deck, may be included within the shaker without departing from the scope of the present disclosure.

As shown, the first screening deck 211 and/or the second screening deck 221 may have one or more channels 213. For example, the first screening deck 211 may include a first channel 213A, a second channel 213B, and a third channel 213C. Further, the second screening deck 221 may include a first channel 223A and a second channel 223B. However, screening decks 211 and 221 may include one or more channels, depending on the requirements of the screening operation. For example, the first screening deck 211 may include two or more channels 213, and the second screening deck 221 may include one or more channels 223. As such, it should be understood that the second screening deck 221 includes at least one channel, which in some embodiments may be the only channel, to receive and direct drilling fluid.

Further, the shaker 201 may include a feeder 203 coupled thereto, such as having the feeder 203 coupled to a feed end of the shaker 201. The feeder 203 may be used to receive and direct drilling fluid to the first screening deck 211 of the shaker 201. Particularly, the feeder 203 may be used to control and selectively direct drilling fluid to the first screening deck 211 of the shaker 201, such as by selectively directing drilling fluid to the first channel 213A, the second channel 213B, and/or the third channel 213C of the first screening deck 211.

As such, the feeder 203 may have one or more inlets and/or one or more outlets, such as corresponding to the number of channels used within the first screening deck 211, to receive and direct drilling fluid to the one or more channels 213A-C of the first screening deck 211, as desired. In one or more embodiments, the feeder may include one or more gates, valves, and/or any other mechanisms that may be used to facilitate receiving and/or directing drilling fluid to the shaker. Further, in one or more embodiments, the feeder may include one or more stationary screens included therewith, such as by having one or more screens disposed within the feeder to facilitate separating solids from the drilling fluid before having the drilling fluid directed to a screening deck of the shaker. Furthermore, as shown, one or more motors 209 may be coupled and/or attached to the shaker 201 to provide vibratory motion while separating solids from drilling fluid with the shaker 201.

A screening mesh may be provided on each of the screening decks of the shaker, and, more particularly, may be provided on each of the channels of the screening decks of the shaker. The screening mesh may be used to filter out and separate solids of various sizes from drilling fluid according to the size of the respective screening mesh. As such, in FIGS. 2A-2F, screening mesh may be provided for the channels 213A-213C of the first screening deck 211, and may also be provided for the channels 223A and 223B of the second screening deck 223. Further, in one or more embodiments, the size of the screening mesh used for the channels of the screening decks may vary such that the channels of the screening decks may be capable of filtering out and separating solids of various sizes.

For example, the screening decks may use or incorporate screening mesh of different sizes, such as by having a coarser screening mesh on the first screening deck 211 and a finer screening mesh on the second screening deck 221, such that the second screening deck 221 may be capable of filtering out and separating solids having a smaller size as compared to that of the first screening deck 211. Furthermore, the channels of the screening decks may use or incorporate screening mesh of different sizes, such as by having a coarser screening mesh on the first channel 213A of the first screening deck 211 and a finer screening mesh on the second channel 213B and/or the third channel 213C of the first screening deck 211. As such, the second channel 213B and/or the third channel 213C may be able to filter out and separate solids having a smaller size as compared to that of the first channel 213A.

Referring still to FIGS. 2A-2F, the first screening deck 211 may include a feed end 215 and a discharge end 217, and similarly the second screening deck may include a feed end 225 and a discharge end 227. Particularly, the channels 213A-213C of the first screening deck 211 may include feed ends 215A-215C and discharge ends 217A-217C, respectively, and the channels 223A and 223B of the second screening deck 221 may include feed ends 225A and 225B and discharge ends 217A and 217B, respectively. The feed ends 215 of the screening decks 211 and 221 may be used to receive drilling fluid onto the screening decks 211 and 221, and the discharge ends 217 may be used to discharge solids separated from drilling fluid from the screening decks 211 and 221 and from the shaker 201.

A shaker in accordance with one or more embodiments of the present disclosure may also include one or more flowback pans. For example, as shown in FIGS. 2A-2F, a flowback pan 231 may be used to receive drilling fluid separated from solids with one or more of the channels 213A-213C of the first screening deck 211 and direct the drilling fluid to one or more of the channels 223A and 223B of the second screening deck 221 of the shaker 201. Additionally, or alternatively, the flowback pan 231 may be used to receive drilling fluid separated by one or more of the channels 213A-213C of the first screening deck 211 and direct the drilling fluid to a sump 241 of the shaker 201. Drilling fluid directed to the sump 241 of the shaker 201 may be collected by the sump 241, such as for re-use when drilling.

In accordance with embodiments disclosed herein, a shaker 201 may include one or more flowback pans 231 therewith, or may not include any flowback pans 231. Further, a flowback pan 231 may be separated into multiple separate flowback pans 231. For example, rather than having a flowback pan 231 positioned beneath and between the first screening deck 211 and the second screening deck 221, multiple flowback pans 231 may be positioned beneath the different channels 213A-213C of the first screening deck 211. As such, different shapes, sizes, structures, arrangements, and configurations may be used for a flowback pan 231 without departing from the scope of the present disclosure.

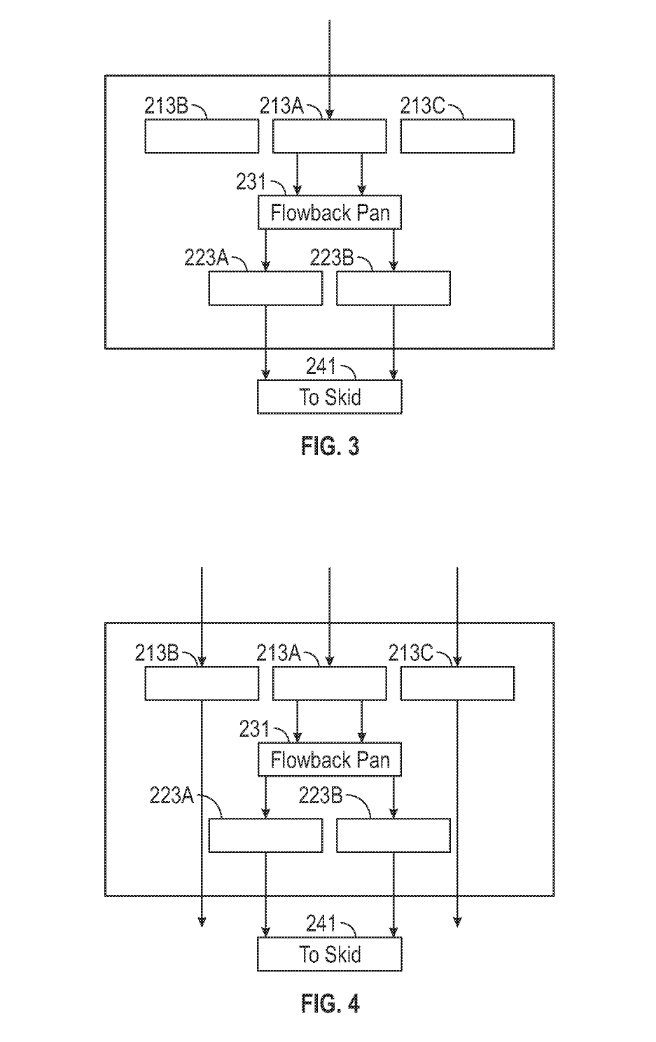

As discussed above, a shaker 201 in accordance with the present disclosure may be used in a series configuration and/or a parallel configuration when separating solids from the drilling fluid. Accordingly, with respect to FIGS. 2A-2F, and also as demonstrated particularly in FIG. 2E and a block diagram in FIG. 3, in a series configuration, drilling fluid may be directed to the first channel 213A of the first screening deck 211. As drilling fluid is directed to the first channel 213A of the first screening deck 211, the first channel 213A may receive the drilling fluid at the feed end 215A and then separate solids from the drilling fluid with the first channel 213A of the first screening deck 211. As such, solids from the drilling fluid having a larger size than that of the screening mesh of the first channel 213A may be discharged off from the discharge end 217A of the first channel 213A of the first screening deck 211.

Further, drilling fluid may pass and flow through the screening mesh of the first channel 213A. As such, in an embodiment in which the flowback pan 231 is included within the shaker 201, the drilling fluid may then be received by the flowback pan 231 such as to direct the drilling fluid to the second screening deck 221. Particularly, the flowback pan 231 may be used to direct drilling fluid to the first channel 223A and/or the second channel 223B of the second screening deck 221, such as to the feed ends 225A and 225B of the first channel 223A and the second channel 223B, respectively. However, in an embodiment in which a flowback pan is not included within the shaker 201, the drilling fluid may flow through the screening mesh to be directed and fall directly onto the first channel 223A and/or the second channel 223B of the second screening deck 221. In one or more embodiments, a flowback pan 231 may be used to prevent unnecessary wearing of one or more screening decks of the shaker.

As drilling fluid is directed to the first channel 223A and/or second channel 223B of the second screening deck 221, the channels 223A and 223B may be used to separate solids from the drilling fluid received therein. Particularly, solids from the drilling fluid having a larger size than that of the screening mesh of the first channel 223A and/or the second channel 223B may be discharged off from the discharge ends 227A and/or 227B of the channels 223A and/or 223B of the second screening deck 221. Further, the drilling fluid may pass and flow through the screening mesh of the channels 223A and/or 223B, in which the drilling fluid may then be directed to the sump 241 of the shaker 201. As discussed above, the block diagram in FIG. 3 shows a representation of this series flow configuration within the shaker 201. Furthermore, and as discussed above, the first channel 213A of the first screening deck 211 may have a coarser screening mesh as compared to the screening mesh of the first channel 223A and/or the second channel 223B of the second screening deck 221.

Continuing, in a parallel flow configuration, drilling fluid may still be directed to the first channel 213A of the first screening deck 211, as discussed above with respect to FIGS. 2E and 3, such that drilling fluid may be directed to the sump 241 of the shaker 201 through the first channel 223A and/or the second channel 223B of the second screening deck 221. Further, and also as particularly demonstrated in FIG. 2F and in a block diagram in FIG. 4, drilling fluid may also be directed to the second channel 213B and/or the third channel 213C of the first screening deck 211. As drilling fluid is directed to the channels 213B and/or 213C of the first screening deck 211, the channels 213B and/or 213C may receive the drilling fluid at the feed ends 215B and 215C thereof, in which the channels 213B and/or 213C of the first screening deck 211 may be used to separate solids from the drilling fluid. As such, solids from the drilling fluid having a larger size than that of the screening mesh of the channels 213B and/or 213C may be discharged off from the discharge ends 217B and/or 217C of the channels 213B and/or 213C of the first screening deck 211.

Further, the drilling fluid may pass and flow through the screening mesh of the channels 213B and/or 213C, in which the drilling fluid may then be directed to the sump 241 of the shaker 201. For example, as discussed above, the flowback pan 231 (if desired), or another separate flowback pan, may be used to direct the drilling fluid from the channels 213B and/or 213C of the first screening deck 211 to the sump 241 of the shaker 201. However, in one or more embodiments, a flowback pan may not be used, in which other means, such as the sides or the rear of the shaker 201 may be used to direct the drilling fluid to the sump 241 of the shaker 201.

As discussed above, the block diagram in FIG. 4 shows a representation of this parallel flow configuration within the shaker 201. Furthermore, and also as discussed above, the second channel 213B and/or the third channel 213C of the first screening deck 211 may have a finer screening mesh as compared to the first channel 213A of the first screening deck 211, such as by having a substantially similar size of screening mesh between the second channel 213B and/or the third channel 213C of the first screening deck 211 and the first channel 223A and/or the second channel 223B of the second screening deck 221.

In accordance with one or more embodiments of the present disclosure, one or more of the screening decks, and one or more of the channels of the screening decks, may be disposed at different deck angles with respect to each other. For example, one or more of the channels 213A-213C of the first screening deck 211 and one or more of the channels 223A and 223B of the second screening deck 221 may be disposed at and movable between different deck angles with respect to each other, if desired.

In one embodiment, the first screening deck 211 may be disposed at a different deck angle than that of the second screening deck 221. In another embodiment, the first channel 213A of the first screening deck 211 may be disposed at about zero degrees, whereas the second channel 213B and/or the third channel 213C of the first screening deck 211 may be disposed at an incline of about four degrees, as shown in FIGS. 2E and 2F particularly. This may enable a lower deck angle to be used when large, and often heavier, solids are conveyed within the drilling fluid by the channels and the screening decks for separation. This may also enable a larger pond depth to be used on the channels and screening decks to increase fluid capacity of the shaker. As such, the deck angles of the channels of the screening decks may be movable and changed with respect to each other to change and adjust the fluid capacity of the shaker. Furthermore, in one or more embodiments, the channels and the screening decks may be disposed at compound angles, such as by having a different angle for one or more of the channels at the feed end of the shaker as compared to the discharge end of the shaker.

Referring now to FIGS. 3-10, multiple views of block diagrams of the flow configuration of a shaker in accordance with one or more embodiments disclosed herein are shown. As discussed above, FIG. 3 shows a flow configuration for a series configuration within the shaker 201, and FIG. 4 shows a flow configuration for a parallel configuration within the shaker 201.

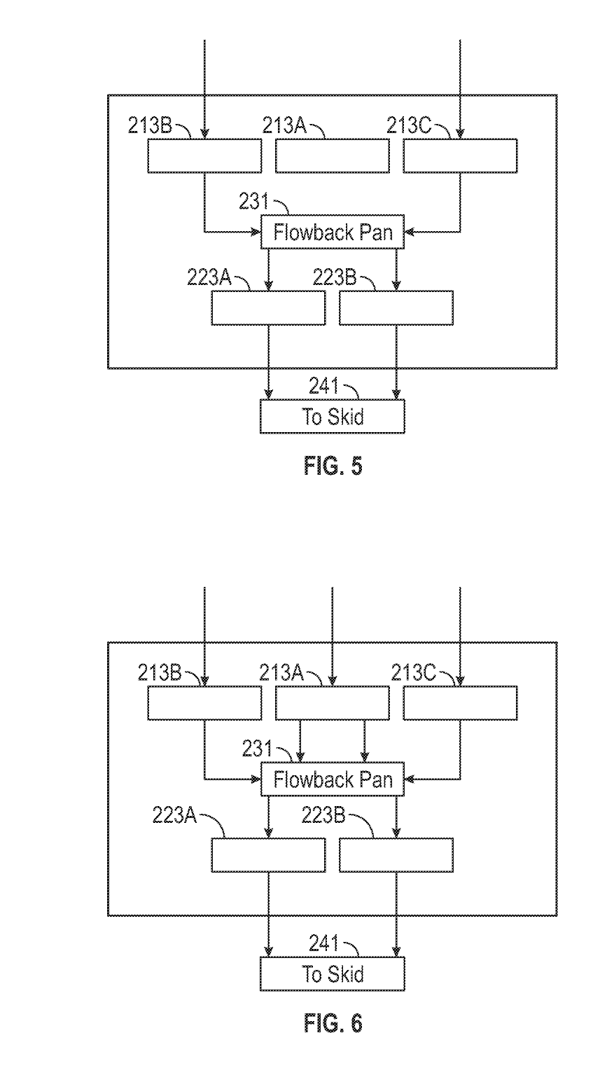

Further, as shown in FIGS. 5 and 6, rather than having the second channel 213B and/or third channel 213C of the first screening deck 211 direct drilling fluid to the sump 241 of the shaker 201, the second channel 213B and/or third channel 213C of the first screening deck 211 may have drilling fluid directed to the first channel 223A and/or the second channel 223B of the second screening deck 221. For example, drilling fluid may be received from the second channel 213B and/or third channel 213C of the first screening deck 211 by the flowback pan 231 (if present), in which the flowback pan 231 may direct the drilling fluid to the first channel 223A and/or the second channel 223B of the second screening deck 221. As such, one or more of the channels of the first screening deck may be used to selectively direct drilling fluid to the second screening deck of the shaker and/or the sump of the shaker. In such embodiments, the screening mesh of one or more of the channels of the first screening deck may be coarser than the screening mesh of one or more of the channels of the second screening deck.

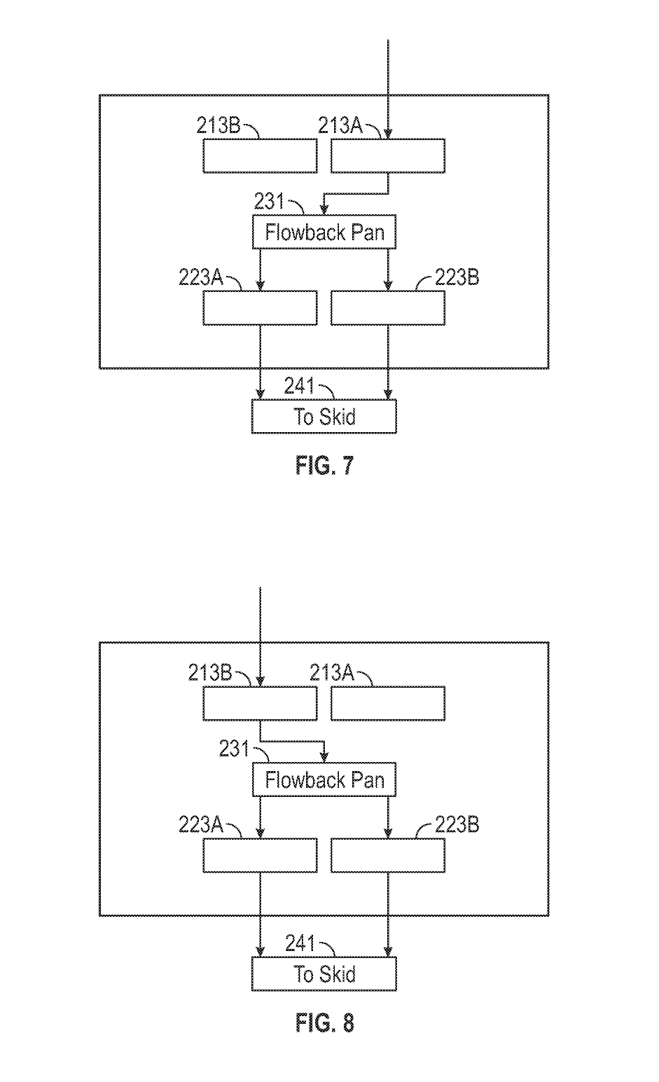

As shown in FIGS. 7 and 8, in an embodiment in which the shaker 201 only includes the first channel 213A and the second channel 213B of the first screening deck 211, the shaker 201 may be used to separate solids from drilling fluid in a series configuration, similar to as shown in FIG. 3. In such embodiments, when in use, drilling fluid may be selectively directed to the first channel 213A and/or the second channel 213B of the first screening deck 211, as desired, in particular if the first channel 213A and the second channel 213B have different flow rate and fluid capacity characteristics with respect to each other.

With respect to FIGS. 7 and 8, the channels 213A and 213B may have a different deck angle and/or a different screening mesh with respect to each other, in which it may be desirable to direct drilling fluid to the first channel 213A and/or the second channel 213B of the first screening deck 211 to increase and/or decrease fluid capacity of the shaker 201. In one embodiment, the first channel 213A may have an inclined deck angle of about three degrees, and the second channel 213B may have a deck angle of about zero degrees. In such an embodiment, to increase the fluid capacity of the shaker, the flow configuration shown in FIG. 7 may be preferred, whereas for drilling fluid having larger harder to convey solids, the flow configuration shown in FIG. 8 may be preferred. Additionally, in such an embodiment, the first channel 213A may have a different sized screening mesh than that of the second channel 213B, such as by having a coarser and/or finer screening mesh for the second channel 213B, as desired.

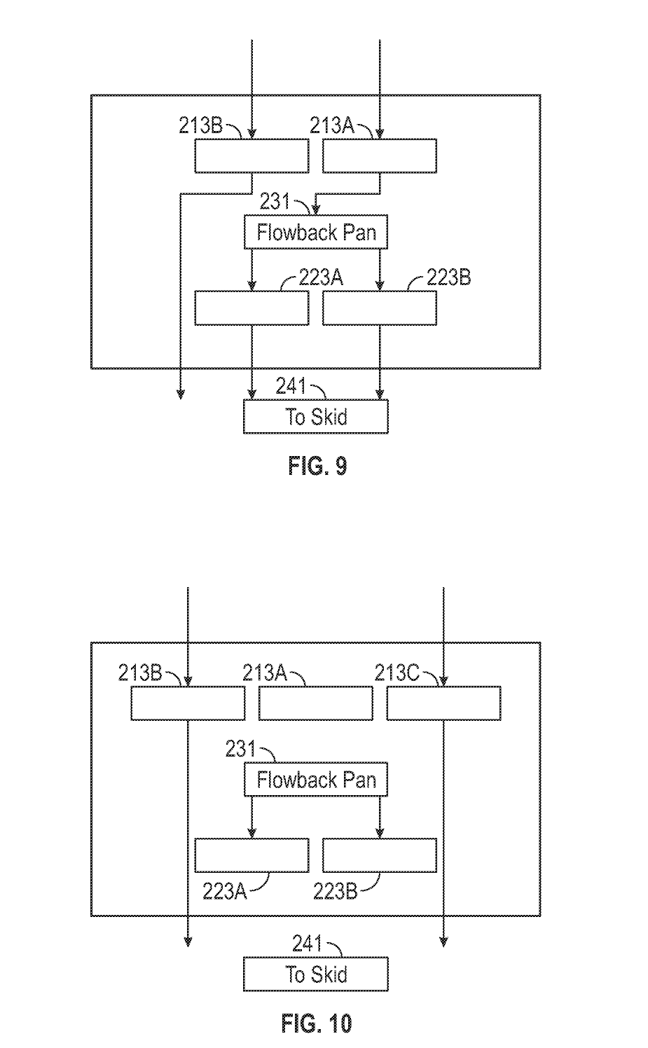

Further, as shown in FIG. 9, in an embodiment in which the shaker 201 only includes the first channel 213A and the second channel 213B of the first screening deck 211, the shaker 201 may be used to separate solids from drilling fluid in a parallel configuration similar to as shown in FIG. 4. Furthermore, as shown in FIG. 10, in an embodiment in which the shaker 201 includes the first channel 213A, the second channel 213B, and the third channel 213C, the shaker 201 may only receive drilling fluid in the second channel 213B and/or the third channel 213C, in which the shaker 201 may then direct the drilling fluid to the sump 241.

As mentioned above, the shaker is not limited to an arrangement of only two screening decks. As such, the shaker may include more than two screening decks, and the arrangement of the screening decks may vary with respect to each other. For example, rather than having the first screening deck arranged above the second screening deck, the screening decks may be arranged side-by-side configuration, or in other configurations. For example, in one embodiment, the shaker may include multiple deck separators, such as the MD-3 Shale Shaker, commercially available from M-I, L.L.C., a Schlumberger Company, in Houston, Tex. Accordingly, the number, arrangement, and configuration of screening decks used with the shaker should not be considered a limitation of the present disclosure.

Advantageously, one or more embodiments disclosed herein may provide a more efficient shaker. In particular, embodiments disclosed herein may provide for a shaker that may seamlessly be able to change flow configurations. For example, the shaker may not need to be powered off to reconfigure the flow of the shaker. Rather, drilling fluid may be redirected through the shaker, as desired, by changing the flow through the feeder and the configuration of one or more of the flowback pans included within the shaker. Further, embodiments disclosed herein may provide for a shaker that may be able to have multiple deck angles, such as multiple deck angles for different channels and/or different screening decks. For example, in one embodiment, one or more channels of the first screening deck may be disposed at and/or movable between different deck angles with respect to one or more channels of the first screening deck and/or the second screening deck, if desired. Furthermore, embodiments disclosed herein may provide for a shaker with an increased effective screening area. For example, as shown in FIGS. 2A-2F, the first screening deck may have an increased size over that of traditional shakers, in which one or more springs brackets of the shaker may be attached to the bottom of the first screening deck, thereby increasing the screening area of the shaker of the present disclosure. While embodiments disclosed herein have been described as separating solids from a drilling fluid, the separation of solids from other types of fluids could also be accomplished by the embodiments and shaker configurations described herein.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed:

1. A shaker comprising:
a first screening deck having a first channel and a second channel; and
a second screening deck;
wherein fluid received by the first channel and separated through the first screening deck is directed to the second screening deck; and
wherein fluid received by the second channel and separated through the first screening deck is directed to a sump of the shaker.

2. The shaker of claim 1, wherein the second screening deck has a channel, wherein fluid received by the first channel and separated through the first screening deck is directed to the channel of the second screening deck.

3. The shaker of claim 1, wherein fluid received by the second channel and separated through the first screening deck is directed to the second screening deck.

4. The shaker of claim 1, further comprising a flowback pan positioned beneath the first screening deck to direct fluid received and separated by the first channel of the first screening deck to the second screening deck.

5. (canceled)

6. The shaker of claim 4,
wherein the flowback pan comprises a first flowback pan and a second flowback pan,
wherein the first flowback pan is positioned beneath the first channel of the first screening deck to direct fluid received and separated by the first channel of the first screening deck to the second screening deck, and
wherein the second flowback pan is positioned beneath the second channel of the first screening deck to direct fluid received and separated by the second channel of the first screening deck to the sump of the shaker.

7. The shaker of claim 4, wherein the flowback pan directs fluid received and separated by the second channel of the first screening deck to the second screening deck.

8. The shaker of claim 1,
wherein the first screening deck further comprises a third channel, and
wherein fluid received by the third channel and separated through the first screening deck is directed to the sump of the shaker.

9. The shaker of claim 8, wherein at least one of the second channel and the third channel of the first screening deck directs separated fluid to the second screening deck.

10. The shaker of claim 8, further comprising a flowback pan positioned beneath the first channel of the first screening deck to direct fluid received and separated by the first channel of the first screening deck to the second screening deck.

11. The shaker of claim 10,
wherein the flowback pan comprises a first flowback pan, a second flowback pan, and a third flowback pan,
wherein the first flowback pan is positioned beneath the first channel of the first screening deck and directs fluid received and separated by the first channel of the first screening deck to the second screening deck,
wherein the second flowback pan is positioned beneath the second channel of the first screening deck and directs fluid received and separated by the second channel of the first screening deck to the sump of the shaker, and
wherein the third flowback pan is positioned beneath the third channel of the first screening deck and directs fluid received and separated by the fourth channel of the first screening deck to the sump of the shaker.

12. The shaker of claim 1, further comprising a feeder coupled to the shaker to direct fluid to at least one of the first channel and the second channel of the first screening deck, or wherein the first channel and the second channel of the first screening deck are disposed at different deck angles with respect to each other.

13. (canceled)

14. (canceled)

15. (canceled)

16. A method to separate solids from drilling fluid, the method comprising:
receiving drilling fluid onto a first channel of a first screening deck, the first screening deck having the first channel and a second channel;
separating solids from drilling fluid in the first channel of the first screening deck;
directing drilling fluid from the first channel of the first screening deck onto a second screening deck; and
separating solids from drilling fluid in the second screening deck;
wherein drilling fluid received by the second channel and separated through the first screening deck is directed to a sump of the shaker.

17. The method of claim 16, further comprising:
receiving drilling fluid onto the second channel of the first screening deck;
separating solids from drilling fluid with the second channel of the first screening deck; and
directing drilling fluid from the second channel of the first screening deck to the sump of the shaker.

18. The method of claim 16, wherein drilling fluid received and separated by the second channel of the first screening deck is directed to the second screening deck, or wherein a flowback pan directs drilling fluid from the first channel of the first screening deck onto the second screening deck.

19. (canceled)

20. The method of claim 16, wherein the second screening deck comprises at least one channel, further comprising:
directing drilling fluid from the first channel of the first screening deck onto the at least one channel of the second screening deck; and
separating solids from drilling fluid in the at least one channel of the second screening deck.

21. The method of claim 16, further comprising:
receiving drilling fluid onto a third channel of the first screening deck;
separating solids from drilling fluid in the third channel of the first screening deck; and
directing drilling fluid from the third channel of the first screening deck to the sump of the shaker.

22. The method of claim 16, wherein at least one of the first channel and the second channel of the first screening deck and the second screening deck are disposed at different deck angles with respect to another of the first channel and the second channel of the first screening deck and the second screening deck.

23. A method comprising:
operating a shaker in a series configuration to process drilling fluid, comprising:
receiving drilling fluid in a first channel of a first screening deck of the shaker, the first screening deck having the first channel and a second channel;
separating solids from drilling fluid in the first channel of the first screening deck;
directing drilling fluid from the first channel of the first screening deck onto a second screening deck of the shaker;
separating solids from drilling fluid in the second screening deck; and
directing drilling fluid from the second screening deck to a sump of the shaker;
operating the shaker in a parallel configuration to process drilling fluid, comprising:
receiving drilling fluid in the second channel of the first screening deck of the shaker;
separating solids from drilling fluid in the second channel of the first screening deck;
directing drilling fluid from the second channel of the first screening deck to the sump of the shaker;
receiving drilling fluid in the second screening deck of the shaker;
separating solids from drilling fluid in the second screening deck; and
directing drilling fluid from the second screening deck to the sump of the shaker; and
adjusting between operating the shaker in the series configuration and in the parallel configuration to process drilling fluid.

24. The method of claim 23, further comprising:
adjusting a deck angle of at least one of the first channel and the second channel of the first screening deck and the second screening deck with respect to another of the first channel and the second channel of the first screening deck and the second screening deck.

25. The method of claim 23, wherein a screening mesh of the first channel of the first screening deck is coarser than a screening mesh of the second channel of the first screening deck.

26. (canceled)
